(19) United States
(12) Patent Application Publication
(10) Pub. No.: US 2013/0231112 A1
(43) Pub. Date: Sep. 5, 2013

(54) METHOD FOR TRIGGERING JOINT REGISTRATION PERFORMED BY LTE SINGLE-CARD DUAL-STANDBY MULTI-MODE TERMINAL, AND TERMINAL

(71) Applicant: Xiaopeng Zhang, Xi'an (CN)

(72) Inventor: Xiaopeng Zhang, Xi'an (CN)

(73) Assignee: Huawei Device Co., Ltd., Shenzhen (CN)

(21) Appl. No.: 13/594,510

(22) Filed: Aug. 24, 2012

(30) Foreign Application Priority Data
Dec. 13, 2011 (CN) 201110415114.9

(51) Int. Cl. H04W 60/00

(52) U.S. Cl. CPC H04W 60/005
USPC 455/435.1

(57) ABSTRACT

Embodiments of the present invention relates to a method for triggering joint registration performed by an LTE single-card dual-standby multi-mode terminal, and a terminal, so as to solve a technical problem in the prior art that LTE network registration and 2G/3G network registration are separately performed so the power consumption of the terminal is increased. The joint registration method includes: determining, by a terminal, a location area identity of a 2G/3G network in which registration is to be performed; and, sending, by the terminal, an attach request message to a mobile management entity of an LTE network, where the attach request message contains the location area identity, so as to trigger the joint registration which is in the LTE network and the 2G/3G network and is performed together by the terminal and the mobile management entity of the LTE network.

### CROSS-REFERENCE TO RELATED APPLICATIONS

This application claims priority to Chinese Patent Application No. 201110415114.9, filed on Dec. 13, 2011, which is hereby incorporated by reference in its entirety.

### FIELD OF THE INVENTION

The present invention relates to the field of communication technology, in particular, to a method for triggering joint registration performed by an LTE single-card dual-standby multi-mode terminal, and a terminal.

### BACKGROUND OF THE INVENTION

An LTE (Long Term Evolution, 3GPP long term evolution network) single-card dual-standby multi-mode terminal refers to a terminal camping on two communication subsystems at the same time, and the two communication subsystems are an LTE communication subsystem and a 2G/3G communication subsystem. A CS domain (Circuit Switch, circuit switch) of the terminal camps on a 2G/3G network and is used for a voice service; and a PS domain (Packet Switch, packet switch) camps on an LTE network and is used for a data service. A greatest advantage of the LTE single-card dual-standby multi-mode terminal lies in that, because it camps on the two communication systems at the same time, the quality of its voice service and the quality of its data service may be guaranteed at the same time, especially, the quality of its voice service is consistent with that of the 2G/3G terminal, and a problem of the LTE single-card single standby multi-mode terminal that communication quality is unstable when the voice service is used is effectively avoided. At present, there are already some operators, for example, the China Mobile, considering adopting this terminal solution when deploying the LTE network.

In the prior art, a registration process of the LTE single-card dual-standby multi-mode terminal is that: the terminal performs CS domain registration in the 2G/3G network and PS domain registration in the LTE network, and these two registration processes are independent of each other. A problem existing in the registration process is that: two network registration processes are required, the number of network signaling interactions is increased, which causes a waste of air interface resources, also causes increase of the power consumption of the terminal, and is to the disadvantage of maintaining the standby time of the terminal.

In addition, a joint registration method of a single-card single standby multi-mode terminal also exists in the prior art, that is, a voice function of the LTE network is implemented through a CS fallback (CS Fallback, CSFB) solution provided in a 3GPP protocol (TS 23.272). In order to support the CSFB, the single-card single standby multi-mode terminal uses the joint registration method during the network registration, that is, the registration is performed at the same time in CS domains of the LTE network and the 2G/3G network through wireless signaling of the LTE network. A problem existing in the joint registration method of the single-card single standby multi-mode terminal is that a 2G/3G network in which registration is performed is determined by the LTE network, and the network determined by the LTE may not be the best network, which is to the disadvantage of subscriber experience.

### SUMMARY OF THE INVENTION

Embodiments of the present invention provide a method for triggering joint registration performed by an LTE single-card dual-standby multi-mode terminal, and an LTE single-card dual-standby multi-mode terminal.

The method for triggering joint registration performed by an LTE single-card dual-standby multi-mode terminal is as follows:
determining, by a terminal, a location area identity of a 2G/3G network in which registration is to be performed; sending, by the terminal, an attach request message to a mobile management entity of an LTE network, where the attach request message contains the location area identity, so as to trigger joint registration which is in the LTE network and the 2G/3G network and is performed together by the terminal and the mobile management entity of the LTE network.

The LTE single-card dual-standby multi-mode terminal includes:
a registration network determining unit, configured to determine a location area identity of a 2G/3G network in which registration is performed; and
an attach request message sending unit, configured to send an attach request message to a mobile management entity of an LTE network, where the attach request message contains the location area identity.

Through the foregoing technical solutions provided by the embodiments of the present invention, the joint registration in the 2G/3G network and the LTE network may be implemented through one network registration process, the number of network signaling interactions is reduced, and the power consumption of the terminal is saved, which is to the benefit of prolonging the standby time of the terminal and improving subscriber experience. Meanwhile, in the joint registration, the 2G/3G network in which registration is performed is decided by the terminal side, which improves a subscriber's autonomy and further improves the subscriber experience.

### BRIEF DESCRIPTION OF THE DRAWINGS

To illustrate technical solutions in embodiments of the present invention more clearly, accompanying drawings to be used in the description of the embodiments are introduced briefly in the following. Apparently, the accompanying drawings in the following description are only some embodiments of the present invention, and persons of ordinary skill in the art can derive other drawings from these accompanying drawings without creative efforts.

FIG. 1 is a flowchart of Embodiment 1 of the present invention;

FIG. 2 is a flowchart of Embodiment 2 of the present invention;

FIG. 3 is a structural diagram of Embodiment 3 of the present invention.

FIG. 4 is a structural diagram of Embodiment 3 of the present invention.

### DETAILED DESCRIPTION OF THE EMBODIMENTS

To make purposes, technical solutions and advantages of the present invention clearer, specific embodiments of the present invention will be further described below in detail with reference to the accompanying drawings.

### Embodiment 1

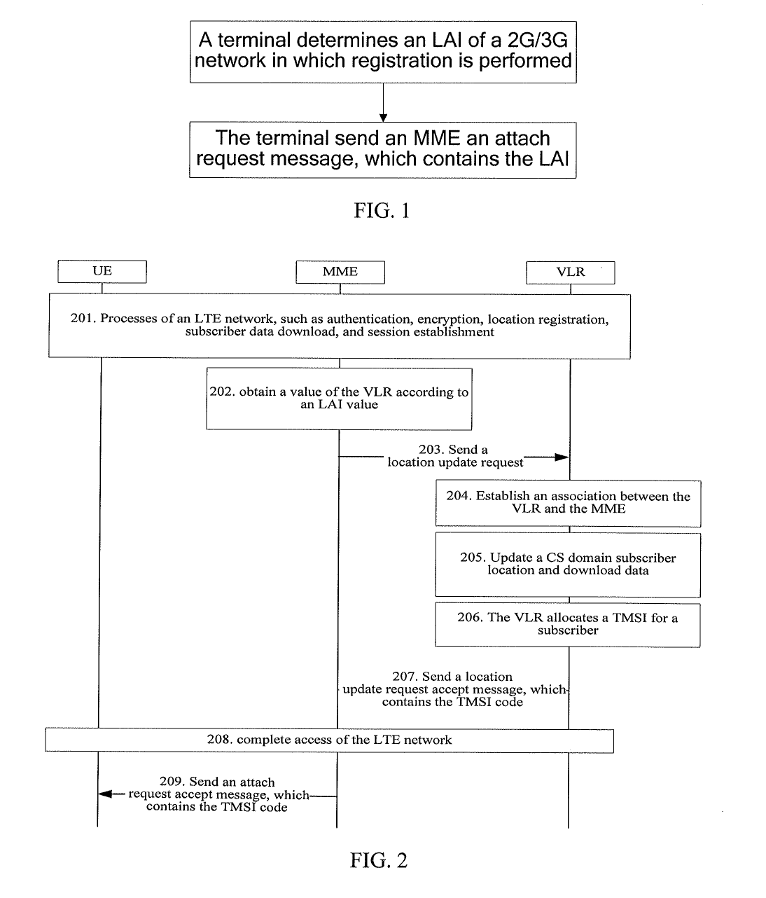

Embodiment 1 of the present invention provides a method for triggering joint registration which is in a 2G/3G network and an LTE network and is performed by an LTE single-card dual-standby multi-mode terminal. FIG. 1 is a flowchart of Embodiment 1 of the present invention, and the method in Embodiment 1 of the present invention is illustrated below in detail with reference to FIG. 1.

Step 101: After a terminal device starts up, start a 2G/3G radio frequency system and a LTE radio frequency system, and begin to search for a network. The terminal determines a 2G/3G network in which registration is to be performed and its location area identity (Location Area Identify, LAI) by comparing a determined available network list in a network searching result of a 2G/3G network with network selecting information of a public land mobile network (Public Land Mobile Network, PLMN) in a SIM card.

Step 102: The terminal sends an attach request message to a mobile management entity (Mobile Management Entity, MME) of an LTE network, where the attach request message contains the LAI of the 2G/3G network determined in step 1, so as to trigger joint registration which is in the LTE network and the 2G/3G network and is performed together by the terminal and the mobile management entity. Optionally, the attach request message may further contain an access type, and the joint registration is designated to be performed in the access type. When the access type is not carried in the attach request message, it may be defaulted to perform the joint registration according to the protocol.

Optionally, the method for triggering the joint registration which is in the 2G/3G network and the LTE network and is performed by the LTE single-card dual-standby multi-mode terminal, may further include:
before the terminal sends the attach request message to the MME, determining, according to a remaining electric quantity of a battery of the terminal, whether to perform the joint registration, which specifically is:
detecting the remaining electric quantity of the battery of the terminal;
sending, by the terminal, the attach request message to the MME, if the remaining electric quantity of the battery is greater than an electric quantity threshold.

In Embodiment 1 of the present invention, it may be implemented that the joint registration which is in the LTE network and the 2G/3G network and is performed by the LTE single-card dual-standby multi-mode terminal, is triggered, so as to reduce air interface signaling consumption caused by separate registration of the LTE single-card dual-standby multi-mode terminal in the 2G/3G network and in the LTE network. Meanwhile, by an optional solution in Embodiment 1 of the present invention, it may be implemented that a registration standby network of the LTE single-card dual-standby multi-mode terminal is determined according to the remaining electric quantity of the battery, which solves a problem in the prior art that a uniform registration policy is adopted without considering the electric quantity of the battery, so as to reduce the power consumption of the terminal, and prolong standby time of the terminal.

### Embodiment 2

Embodiment 2 of the present invention provides a method for performing joint registration of an LTE single-card dual-standby multi-mode terminal in a 2G/3G network and an LTE network according to the triggering method provided in Embodiment 1. FIG. 2 is a flowchart of Embodiment 2 of the present invention, and the method of Embodiment 2 of the present invention is illustrated below in detail with reference to FIG. 2.

After a terminal device sends a mobile management entity an attach request message which contains an LAI, the terminal device, the MME and a visitor location register (Visitor Location Register, VLR) of the a 2G/3G network together perform the joint registration in the LTE network and the 2G/3G network according to the attach request message. The joint registration specifically includes:

Step 201: The terminal and the MME perform, according to the attach request message, processes of the LTE network, such as certification, authentication, encryption, location registration, subscriber data download, and session establishment. The processes are implemented complying with the 3GPP protocol standard, and are not described in detail.

Step 202: According to an LAI value contained in the attach request message, the MME obtains a value of the visitor location register (VLR) according to an LAI-VLR comparison table, where the value of the visitor location register corresponds to the value of the LAI.

Step 203: The MME sends a location update request to the VLR according to the value of the VLR, where the location update request contains an LAI of a determined 2G/3G network, an international mobile subscriber identity (International Mobile Subscriber Identity, IMSI) of a subscriber, and a name of the MME.

Step 204: The VLR establishes an association between the VLR and the MME according to the location update request, and the establishing the association between the VLR and the MME is specifically: storing, by the VLR, the name of the MME, and mapping the name of the MME to data of the IMSI.

Step 205: The VLR executes a CS domain registration process of the terminal in the 2G/3G network according to the association, the registration process specifically includes updating a subscriber location and downloading subscriber data, where implementation processes of the updating the subscriber location and downloading the subscriber data are the same as those in the prior art, which are not described in detail.

Step 206: The VLR allocates a temperate mobile station identity (Temperate Mobile Station Identity, TMSI) to the terminal according to the downloaded subscriber data.

Step 207: The VLR sends a location update request accept message to the MME, and the location update request accept message contains the allocated TMSI code.

Step 208: The MME, the terminal and a base station eNodeB of the LTE network complete PS domain access of the LTE network, where the access process is implemented complying with the 3GPP protocol standard, and is not described in detail.

Step 209: The MME sends an attach request accept message to the terminal, where the attach request accept message contains the TMSI code that is allocated for the terminal by the VLR, and the terminal confirms, according to the TMSI code, that CS domain registration is successful.

In Embodiment 2 of the present invention, it may be implemented that the joint registration in the LTE network and the 2G/3G network is performed according to the LAI value that is determined by the terminal, so as to reduce air interface signaling consumption that is caused by the separate registration of the LTE single-card dual-standby multi-mode terminal in the 2G/3G network and in the LTE network, which is to the benefit of network roaming and subscriber selection.

### Embodiment 3

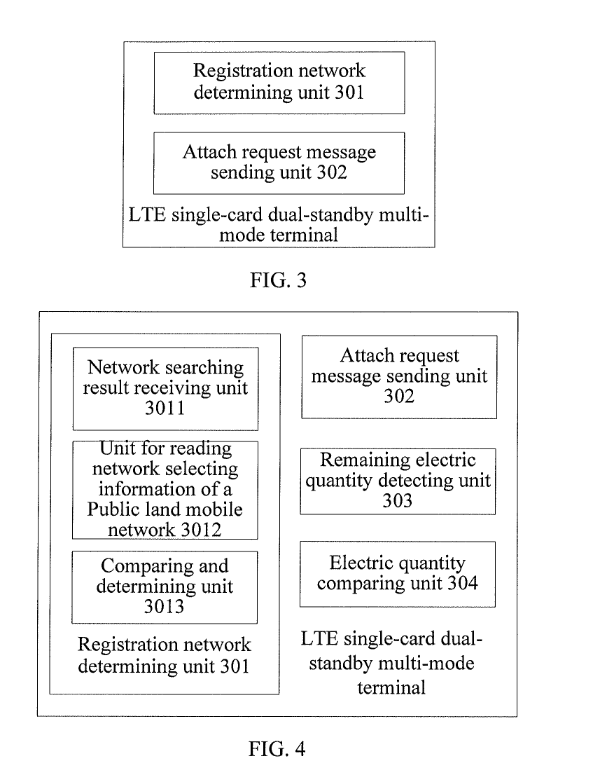

FIG. 3 is a structural diagram of Embodiment 3 of the present invention, and Embodiment 3 of the present invention provides an LTE single-card dual-standby multi-mode terminal capable of performing joint registration, including:
a registration network determining unit 301, configured to determine a 2G/3G network in which registration is to be performed and its location area identity (Location Area Identify, LAI) by comparing a determined available network list in a network searching result of a 2G/3G network with network selecting information of a public land mobile network (Public Land Mobile Network, PLMN) in a SIM card. As shown in FIG. 4, the registration network determining unit 301 specifically includes:
a network searching result receiving unit 3011, configured to receive a network searching result of a 2G/3G radio frequency system of the terminal;
a unit for reading network selecting information of a public land mobile network 3012, configured to read the network selecting information of the public land mobile network in the SIM card inserted into the terminal by a subscriber;
a comparing and determining unit 3013, configured to compare the network searching result received by the network searching result receiving unit with the network selecting information of the public land mobile network read by the public land mobile network selecting information reading unit, and determine the location area identity of the 2G/3G network in which registration is to be performed.
an attach request message sending unit 302, configured to send an attach request message to an MME, where the attach request message contains a determined LAI value. Optionally, the attach request message may further contain an access type, and the joint registration is designated to be performed in the access type. Optionally, as shown in FIG. 4, the LTE single-card dual-standby multi-mode terminal may further include:
a remaining electric quantity detecting unit 303, configured to detect a current remaining electric quantity of the terminal; and
an electric quantity comparing unit 304, configured to compare the remaining electric quantity with an electric quantity threshold. If the remaining electric quantity is greater than the electric quantity threshold, an execution instruction is sent to the attach request message sending unit, to trigger sending of the attach request message by the attach request message sending unit to a mobile management entity of an LTE network.

The foregoing embodiments are intended to describe the technical solutions in the present invention but not to limit the invention. Although the present invention is illustrated in detail with reference to the foregoing embodiments, persons of ordinary skill in the art should understand that they can still make modifications to the technical solution recorded in each of the foregoing embodiments, or equivalent replacements to part of technical features in the embodiments of the present invention; and such modifications or equivalent replacements do not make corresponding technical solutions depart from the spirit and scope of the technical solutions provided in the present invention.

It should be noted that persons of ordinary skill in the art should understand that all or part of the steps of the foregoing method embodiments may be completed by hardware, and may also be completed by a program instructing relevant hardware. The program may be stored in a computer readable storage medium, and the storage medium may be a read-only memory, a flash memory, a magnetic disk, an optical disk, a hard disk, or the like. When the program is run, the following steps is included:
determining, by a terminal, a location area identity of a 2G/3G network in which registration is to be performed; and
sending, by the terminal, an attach request message to a mobile management entity of an LTE network, where the attach request message contains the location area identity, so as to trigger the joint registration which is in the LTE network and the 2G/3G network and is performed together by the terminal and the mobile management entity of the LTE network.

What is claimed is:

1. A method for triggering joint registration performed by an LTE single-card dual-standby multi-mode terminal, comprising:
determining, by a terminal, a location area identity of a 2G/3G network in which registration is to be performed; and
sending, by the terminal, an attach request message to a mobile management entity of an LTE network, wherein the attach request message contains the location area identity, so as to trigger joint registration which is in the LTE network and the 2G/3G network and is performed together by the terminal and the mobile management entity of the LTE network.

2. The method for triggering joint registration performed by an LTE single-card dual-standby multi-mode terminal according to claim 1, wherein the determining, by the terminal, the location area identity of the 2G/3G network in which registration is to be performed is specifically:
by comparing a network searching result of a 2G/3G radio frequency system of the terminal with network selecting information of a public land mobile network in a SIM card, determining, by the terminal, the location area identity of the 2G/3G network in which registration is to be performed.

3. The method for triggering joint registration performed by an LTE single-card dual-standby multi-mode terminal according to claim 1, before the sending, by the terminal, the attach request message to the mobile management entity of the LTE network, further comprising:
detecting, by the terminal, a remaining electric quantity of its battery; wherein
the sending, by the terminal, the attach request message to the mobile management entity of the LTE network is specifically:
sending, by the terminal, the attach request message to the mobile management entity of the LTE network, if the remaining electric quantity is greater an electric quantity threshold.

4. The method for triggering joint registration performed by an LTE single-card dual-standby multi-mode terminal according to claim 2, before the sending, by the terminal, the attach request message to the mobile management entity of the LTE network, further comprising:
detecting, by the terminal, a remaining electric quantity of its battery; wherein
the sending, by the terminal, the attach request message to the mobile management entity of the LTE network is specifically:
sending, by the terminal, the attach request message to the mobile management entity of the LTE network, if the remaining electric quantity is greater an electric quantity threshold.

5. The method for triggering joint registration performed by an LTE single-card dual-standby multi-mode terminal according to claim 3, wherein the electric quantity threshold is predetermined by a terminal device.

6. The method for triggering joint registration performed by an LTE single-card dual-standby multi-mode terminal according to claim 4, wherein the electric quantity threshold is predetermined by a terminal device.

7. An LTE single-card dual-standby multi-mode terminal, comprising:
a registration network determining unit, configured to determine a location area identity of a 2G/3G network in which registration is performed; and
an attach request message sending unit, configured to send an attach request message to a mobile management entity of an LTE network, wherein the attach request message contains the location area identity.

8. The LTE single-card dual-standby multi-mode terminal according to claim 7, wherein the registration network determining unit comprises:
a network searching result receiving unit, configured to receive a network searching result of a 2G/3G radio frequency system of the terminal;
a unit for reading network selecting information of a public land mobile network, configured to read network selecting information of a public land mobile network in a SIM card inserted into the terminal by a subscriber; and
a comparing and determining unit, configured to compare the network searching result received by the network searching result receiving unit with the network selecting information of the public land mobile network read by the public land mobile network selecting information reading unit, and determine the location area identity of the 2G/3G network in which registration is to be performed.

9. The LTE single-card dual-standby multi-mode terminal according to claim 7, further comprising:
a remaining electric quantity detecting unit, configured to detect a remaining electric quantity of the terminal; and
an electric quantity comparing unit, configured to compare the remaining electric quantity with an electric quantity threshold, and if the remaining electric quantity is greater than the electric quantity threshold, send an execution instruction to the attach request message sending unit, so as to trigger sending of the attach request message by the attach request message sending unit to the mobile management entity of the LTE network.

10. The LTE single-card dual-standby multi-mode terminal according to claim 8, further comprising:
a remaining electric quantity detecting unit, configured to detect a remaining electric quantity of the terminal; and
an electric quantity comparing unit, configured to compare the remaining electric quantity with an electric quantity threshold, and if the remaining electric quantity is greater than the electric quantity threshold, send an execution instruction to the attach request message sending unit, so as to trigger sending of the attach request message by the attach request message sending unit to the mobile management entity of the LTE network.

11. The LTE single-card dual-standby multi-mode terminal according to claim 9, wherein the electric quantity threshold in the electric quantity comparing unit is predetermined by a terminal device.

12. The LTE single-card dual-standby multi-mode terminal according to claim 10, wherein the electric quantity threshold in the electric quantity comparing unit is predetermined by a terminal device.
